(19) United States
(12) Patent Application Publication
(10) Pub. No.: US 2006/0204722 A1
(43) Pub. Date: Sep. 14, 2006

(54) Surface decoration for a covering part and method for the production thereof

(76) Inventor: Ralf Franzgrote, Iserlohn (DE)

Correspondence Address: FAY KAPLUN & MARCIN, LLP, 15O BROADWAY, SUITE 702, NEW YORK, NY, 10038, US

(21) Appl. No.: 10/566,567

(22) PCT Filed: Jul. 30, 2004
(86) PCT No.: PCT/EP04/08558

§ 371 Date: Jan. 31, 2006

(30) Foreign Application Priority Data
Jul. 31, 2003 (DE) 103 35 433.6

(51) Int. Cl. B29C 45/14; B32B 3/02

(52) U.S. Cl. 428/157; 264/279

(57) ABSTRACT

Described is a surface decoration for a covering part, especially for an inner trim part in a motor vehicle, partially formed by a cast skin. The surface decoration consists of a decorative insert whose edge is adjacent to an area of the surface decoration formed by said cast skin. The edge of the decorative insert is enclosed by the cast skin. Descrived also is a method for the production of a corresponding surface decoration and to a casting tool for the production of said surface decoration. Highly esthetic trim parts can be produced in a highly simple manner.

### FIELD OF THE INVENTION

The present invention relates to a surface decor for a trim part, in particular for an interior trim part for a motor vehicle, and to a method for manufacturing a surface decor as well as to a casting tool for manufacturing such a surface decor

### BACKGROUND INFORMATION

It is known to used cast skins as surface decors for trim parts, wherein the cast skins usually are manufactured by way of filling a casting tool consisting of an upper tool and a lower tool with polyurethane. A trim part may thereby be formed according to the state of the art by way of rear-foaming such cast skin, typically likewise with polyurethane, by which means the cast skin is bought into connection with a carrier. Such trim parts which are particularly applied as interior trim parts for motor vehicles, are characterized by way of a low-effort and inexpensive manufacture, and by way of an appearance which is to be designed in an optically pleasing manner with a cast skin as surface decor. Thereby, one may produce various types of surfaces, in that the cast skin is provided with a certain grain (texture) and color, but the surface remains characterized by the material used for the cast skin, which is polyurethane in the mentioned example. Limits are thus imposed on a comprehensive design of the surface of a viewed side of a trim part with a surface decor of the known type, which may be disadvantageous as soon as aesthetic demands on the design e.g. of a motor vehicle interior for example are given.

### SUMMARY OF THE INVENTION

The present invention realtes to a surface decor as well as a corresponding manufacturing method, wherein on the one hand the surface decor is to comprise a surface design which is more flexible and meets greater aesthetic demands compared to the state of the art and does not exclude more refined materials, but on the other hand the manufacturing method is to remain of similar simplicity to the described state of the art.

To the first extent, a surface design meeting higher aesthetic demands on a viewed side of a corresponding trim part is achieved by way of the fact that the surface decor comprises a decor inlay which may consist of a material which is more refined compared to the cast skin, or one with at least an improved optical appearance, for example of leather, fabric (textile materials such as wovens, knitted fabrics with artificial and/or natural fibers) or polymer materials such as PVC, wherein the decor inlay with an edging borders a region of he surface decor formed by the cast skin. By way of the fact that the edging of the decor inlay is enclosed by the cast skin, that the edging is thus peripherally cased by the cast skin such that the cast skin at the edging has a double-sided contact with the decor inlay, one thereby ensures a clean and likewise aesthetically pleasing connection of the decor inlay to the region formed by the cast skin, wherein this connection is however stable and secure. The described surface decor may be used for a trim part in the same manner as a conventional, single-piece surface decor consisting only of a cast skin, due to this reliable connection.

The suggested method for manufacturing the described surface decor envisages introducing the decor inlay into a casting tool which comprises an upper tool and a lower tool, before the cast skin is cast by way of filling a cavity of this casting tool arising between the upper tool and the lower tool, with a curing material. Thereby, the decor inlay is introduced into the casting tool such that in the region of its edging, it is clamped between the upper tool and the lower tool, wherein the edging of the decor layer projects into the mentioned cavity. On casting the cast skin, this edging is then enclosed by the curing material, by which means the already described secure connection of the cast skin and decor inlay arises. With regard to the terminology selected here, the lower tool is to indicate a tool half which later accommodates a side of the arising surface decor which is visible on the viewed side of the trim part, and an upper tool accordingly, independently of orientation, is to indicate a tool half of the casting tool which bears on the surface decor at the rear side. The described manufacturing method despite the considerably increased design possibilities remains extremely uncomplicated and profits from the advantages which the use of cast skins of surface decors entails.

Thereby, a manufacture of steel lends itself for the upper and lower tool, but other materials such as aluminum for example many also be considered. Thereby, one must take care that a removal of the finished surface decor is not prevented by sticking to the upper- or lower tool, which may be aided by way of depositing a separation layer to the upper and/or lower tool.

In order to prevent a contamination of the decor inlay by way of spillage of the material forming the cast skin, from the region of the surface decor formed by the cast skin, one must observe an adequately good sealing between the upper tool, the decor inlay and the lower tool, at the location where the decor inlay is clamped between the two tool halves close to its edging. This particularly applies to decor inlays containing fibers, with which capillary effects may had to a suctioning of the material forming the cast skin through the decor inlay. A good sealing may be achieved by way of a pinching of the decor inlay at the edging. A particularly stable connection between the decor inlay and the cast skin arises when the decor inlay with its edging projects at least 1 mm, preferably more than 2 mm into the cavity accommodating the arising cast skin, by which means a corresponding overlap of the cast skin and the decor inlay arises at the edging. On the other hand, one must take care that the edging does not project too far into the mentioned cavity, in order to prevent the edging becoming apparent on the surface of the cast skin. One achieves good results when the overlap of the cast skin and the decor inlay perpendicular to the edging is not more than 5 mm, preferably at the most is 3 mm.

Polyurethane is to be preferred as a curing starting material, which on account of an initially very low viscosity may also be filled very well into narrow cavities, under certain circumstances with a complicated geometry and long flow path distances of e.g. up to 2500 mm. What is also exploited is not only that polyurethane fills out a cavity presented to it particularly well, but also has excellent bonding properties, which is advantageous for the secure connection of the cast skin and decor inlay with the most different of decor materials for the decor inlay.

One achieves good results, on the one hand with regard to a material expense which is not too high and a surface which is not too hard, and on the other hand with regard to an adequately high stability of the cast skin, when the cast skin is designed with an average thickness of between 0.7 mm and 1.5 mm. Thicknesses of preferably between 0.3 mm and 2 mm depending on the decor material, are suitable for the decor inlay for the same reasons.

The optical appearance of the corresponding trim part may be additionally influenced in a positive manner by way of designing the cast skin with a paint layer of a desired color on a surface which is later visible on the viewed side of the finished trim part. Inasmuch as a light-insensitive material is applied for the cast skin, such a preferably light-insensitive and opaque material may also serve as a protection of the cast skin from damage caused by light. For application of such a surface layer on manufacture of the cast skin, one may deposit a suitable paint layer which remains on the cast skin after casting the cast skin, onto the lower tool at the location at which is accommodates the arising cast skin, before the filling of the cavity, and preferably also before the introduction of the decor inlay into the casting tool. Prior to this, one may also deposit a separation layer, preferably by way of spraying the lower tol, as the paint layer itself, so that this paint layer does not remain sticking to the lower tool. In order thereby to prevent a contamination of the decor inlay, the lower tool may be covered by a mask in a region accommodating the decor inlay during the casting. For avoiding contamination of the decor inlay or of the corresponding region of the lower tool, alternatively or additionally to this, the lower tool may be divided such that the region accommodating the decor inlay may be lowered individually, and is lowered for depositing the paint layer and/or the separation layer. Such a division of the lower tool into a region accommodating the decor inlay and a region accommodating the cast skin, wherein the latter is designed lowerable, is also advantageous in order to permit an application of one and the same casting tool for different and thus also differently thick decor inlays.

In order to prevent a damage to the decor inlay or a contamination by way of penetrating rear foam mass or rear injection molded mass given a later rear-foaming or rear-injection molding of the surface decor during the manufacture of the correspond trim part, in particularly with the use of material of natural- and/or artificial fiber materials for the decor inlay, the decor inlay may be provided with a rear-side blocking layer. Thereby, it may be the case e.g. of a blocking layer which is deposited by spraying or brushing, or also of a film applied behind the actual decor inlay. Such a layer may be superfluous when the decor inlay consists of a material which is impermeable to the foam.

With a typical and useful design of the invention, the decor inlay forms a middle section of the surface decor which is peripherally bordered by the cast skin, so that the decor inlay thus is encased by the cast skin along a closed edging. One may achieve a particularly pleasant optical design with such an arrangement of the cast skin and decor inlay, which may be particularly advantageously applied for side trims, door interior trims or instrument panels of motor vehicles, which usually characterize the interior of a motor vehicle.

A particularly preferred design of the method for manufacturing the surface decor envisages the lower tool comprising a web along a separating line which terminates the cavity towards the decor inlay, so that the decor inlay at its edging is clamped between this web and the upper tool. Thereby, the upper tool here preferably comprises a recess providing space for the web. With such a web, one firstly achieves a particularly good sealing of the cavity accommodating the arising skin toward the decor inlay by way of being able to exert a locally increased pressure on the decor inlay near to the edging of the decor inlay. With this, one also achieves a very favorable shaping of the surface decor for the appearance of the finished trim part, with which the edging of the decor inlay enclosed by the cast skin is sunk in a groove, so that only one joint which runs parallel to the edging, separates two surface regions, and optically separates the cast skin and the decor inlay optically from one another, remains on the viewed side of the trim part.

The arising groove thereby has a depth which is defined by the web, wherein one must note that a groove which is too deep would render the surface decor very unwieldy for further processing during manufacture of the trim part, but an adequately deep groove on the other hand is desired, in order to avoid a visible groove base on the finished trim part. With regard to this, good results are achieved with a web of a height between 3 mm and 10 mm or with a depth corresponding to a groove forming the mentioned joint. From the same aesthetic points of view, it is desirable for the joint not to leave a gap which is too wide. The gap remaining later on the surface of the trim part between the decor inlay and the cast skin, with a groovelike arrangement of the surface decor in a region surrounding the edging of the decor inlay as described, should not exceed a width of 1.5 mm or even better 0.7 mm.

An embodiment with which the gap or the joint has a disappearing width would be particularly preferred. For this, firstly the mentioned web on the lower tool may be designed with a width of not more than 1.5 mm. Since the web on the other hand must be adequately stable, and not cause damage to the decor inlay despite the required high pressure required for a good sealing, the web however should not be narrower than 0.7 mm. A disappearing or at least significantly smaller gap width on the finished trim part however may be realized by way of pushing the gap together by way of a suitable deformation of the groove, before a further processing of the surface decor, for example before rear-foaming or rear injection molding. So tit this is possible, the decor inlay before the casting of the cast skin may be introduced into the casting tool with a suitable over-dimensioning, which may be possible by way of a suitable shape of the upper tool and/or lower tool in the region accommodating the decor inlay. A deformation of the groove required for closing the joint may also be achieved by applying a vacuum in the joint.

The upper tool too may also be divided such that a region covering the decor inlay may be lifted and lowered with respect to a region terminating the cavity for the arising cast skin. Inasmuch as the lower tool comprises a web of the described type, thereby the liftable and lowerable region of the upper tool should also cover this web. With this, a particularly precise dosing of the pressure on the decor inlay at its edging which is required for sealing the cavity is possible.

In order to ensure a precise positioning of the decor inlay on casting the cast skin and thus a well defined overlap of the decor inlay and cast skin at the edging, the decor inlay may be held and fixed on the upper tool or on the lower tool by way of vacuum. An exact positioning may also be simplified in that the upper tool comprises positioning pins on which the decor inlay is arranged on the upper tool bearing with its edging, on introduction into the casting tool. The positioning pins for this are arranged such that the decor inlay before a closure of the casting tool by way of traveling together the upper tool and the lower tool, is positioned in a correct manner just when the edging of the decor inlay bears on these positioning pins. For the same purpose, one may also use a decor inlay provided with holes at the edging, wherein the holes accommodate pins in the correctly positioned decor inlay, which are attached or integrally formed on the casting tool.

A trim part with a surface decor of the described part may, as already mentioned, be manufactured by way of rear injection molding of the surface decor with a material forming a carrier or by way of laminating the surface decor onto a shape part. However, with regard to a simple manufacture and also pleasant haptic properties of the trim part, a manufacture with which the surface decor is rear-foamed, for which again polyurethane material as a rear-foaming mass is particularly suitable, is to be preferred. By way of the rear-foaming, the surface decor may be brought into connection with a previously manufactured carrier in a simple manner, wherein a manufacture of plastic is particularly suitable for a carrier for an inexpensive trim part. Thereby, one achieves particularly stable trim parts with the use of pressed wood-fiber shape material or LFI components, but other reinforced-reinforced plastics may also be use particularly well.

Haptic properties of the finished trim part with a rear foamed surface decor which are differentiated in regions may be realized by a design of chambers behind the decor surface, which are filled with various foams. Thus for example, the decor inlay may be rear-foamed with a foam which is different to the cast skin.

Not every and any surface geometry may be represented with the described manufacturing method. It has been shown that greatly three-dimensional surface contours may lead to difficulties on sealing, and to the formation of creases of the surface decor in the transition region between the cast skin and the decor inlay. Such problems may however be eliminated by way of slight design adaptations, for example in that an otherwise extraordinarily greatly three-dimensionally contoured part region of a trim part is alleviated by way of enlarging radii and flattening surface courses. In the same manner, it is possible by way of the application of preformed decor inlays, to retain such difficult regions without changes. However, an additional working procedure is required with this. In particular, middle regions of door interior trims which are usually quite plane and are particularly well suitable for a design with a decor layer of the described type are of no problem with regard to this aspect. In this case, it is helpful if the closed casting tool in the region of the decor inlay, at least where this region borders the cavity accommodating the cast skin, has only one gap between the upper tool and the lower tool, of a thickness corresponding to the thickness of the decor layer. By way of this, it is ensured that the decor inlay is not warped in a visible environment of its edging on closing the casting tool.

### BRIEF DESCRIPTION OF THE DRAWINGS

Embodiment examples of the invention are described in the following by way of FIGS. 1 to 4. There are shown in:

FIG. 1 shows as a cross section, a cut-out of a casting tool with a surface decor with this manufacture according to an exemplary embodiment of the present invention;

FIG. 2 shows a surface decor on manufacture in a tool which is modified with respect to FIG. 1;

FIG. 3 shows an earlier working step of a manufacturing method according to the present invention, with the casting tool of FIG. 2 in a corresponding representation; and

FIG. 4 shows as a cross section, a cut-out through a casting tool and an arising surface decor, in a further exemplary embodiment of the present invention.

### DETAILED DESCRIPTION OF THE INVENTION

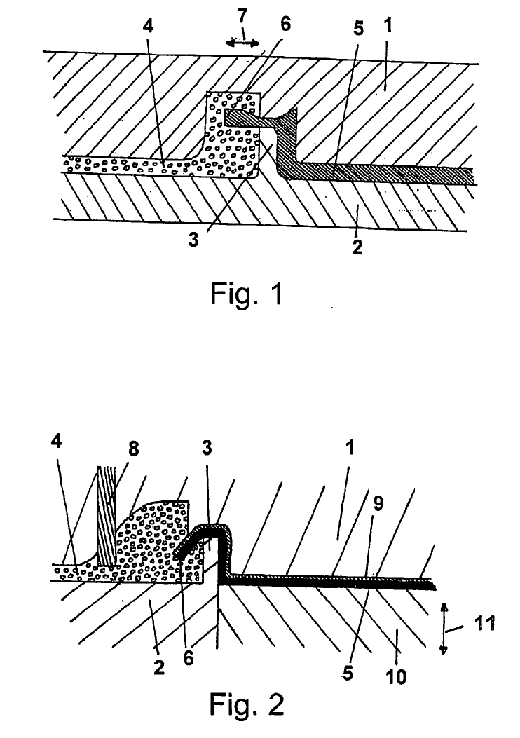

In FIG. 1, one may see a casting tool 1 which comprises an upper tool 1 and a lower tool 2 which are both manufactured of steel. Two regions of this casting tool are separated by a web 3, wherein a cavity which is formed in the Figure into the left of the web 3 between the upper tool 1 and the lower tool 2 is filled with polyurethane for forming a cast skin 4. The other region of the tool accommodates a decor inlay 5 which has been previously introduced into the casting tool, which consists of leather and later forms a middle field of a surface decor of a door interior trim for a motor vehicle, said surface decor formed from the cast skin 4 and the decor inlay 5. For the decor inlay 5 which here, as the cast skin 4, has a thickness of about 1 mm, other materials such as e.g. materials of natural and or artificial fibers or other polymer surface formations would also be considered.

The decor inlay 5 with an edging 6 projects into the cavity between the upper tool 1 and the lower tool, which is already filled with polyurethane in the Figure and in which the cast skin forms, wherein the decor inlay near to this edging 6 is clamped in between the web 3 and the upper tool 1. The cast skin 4 encloses the edging 6 of the decor inlay 5 which projects into the mentioned cavity. Thus a surface decor exists which comprises a region which is formed by the decor inlay 5 and which borders the region of the surface decor formed by the cast skin 4, at the edging 6. For forming a trim part, in the example of the already mentioned door interior trim, this surface decor is subsequently rear-foamed with a polyurethane foam, and specifically by way of foaming in one side of the surface decor, which in the picture has contact with the upper tool 1. The lower tool 2 in the figures accordingly accommodates one side of the arising surface decor which then will form a viewed side of the finished rim part. By way of the rear-foaming, the surface decor is finally brought into connection with a carrier, which for its part consists of pressed wood fiber shape material. Carriers of other materials may also be considered.

On account of the web 3 which in the represented example has a width of about 1 mm, as well as on account of a corresponding shaping of the upper tool 1 providing the web 3 with space, the decor surface in an environment of the edging 6 forms a groove with a depth of about 3 mm which is defined by the web 3, so that a joint or gap remain between the decor inlay 5 and the cast skin 4 on the viewed side. A secure connection of the cast skin 4 with the decor inlay 5 comes into being in that the cast skin 4 and the decor inlay 5 have an overlap of about 2.5 mm which is indicated in the Figure by a double arrow 7, at the location at which he decor inlay 5 is enclosed by the casts skin 4.

FIG. 2 shows another embodiment of the invention, which apart from the already mentioned features which here are indicated with the same reference numerals, comprises a few further features. Here, a positioning pin 8 admitted into the upper tool 1 may be seen, which with other positioning pins which are not shown here, serves for simplifying an exact positioning of the decor inlay 5 before a closure of the casting tool. Before the closure of the casting tool, which is effected by way of traveling the upper tool 1 and the lower tool 2 together, for this, the decor inlay 5 which here consists of fabric, is arranged on the upper tool 1 such that the decor inlay 5 with its edging 6 bears on the positioning pin 8 and the further positioning pins. The decor inlay 5 then on closure of the casting tool, and on casting the cast skin, is held and fixed by way of vacuum applied to the upper tool 1. The upper tool 1 comprises small openings for this purpose. In order to prevent a penetration of foam into the fabric of the decor inlay 5 on subsequent rear-foaming, the decor inlay 5 comprises a blocking layer 9 which is drawn hatched in the Figure, and which in the present embodiment example is formed by a film applied behind the fabric. Another form of rear-side coating of the decor inlay 5 would also be possible for the same purpose.

The cast skin 4 is provided on the viewed side with a paint layer giving it a desired color. For this purpose, the lower tool 2 in the region to the left of the web 3 is provided firstly with a separation layer before the introduction of decor inlay 5 and before the closure of the casting tool, and then provided with a suitable paint layer. This is effected by way of spraying the lower tool 2. In order at the same time to prevent a contamination of the lower tool 2 in the region to the right of the web 3, which would result in the contamination of the decor inlay 5 on the viewed side, the lower tool 2 is designed in a divided manner, so that an insert 10 of the lower tool 2 which then accommodates the decor inlay 5 may be lowered in a direction indicated by a double arrow 11, and lifted again. A lowering of this insert 10 reduces the risk of a contamination of the corresponding region of the lower tool 2 on spraying with paint. The movable insert 10 also permits a comprehensive application of the shown casting tool for decor inlays 5 of different thickness and/or materials. With a subsequent removal of the surface decor from the casting tool, the paint layer firstly deposited onto the lower tool 2 then remains on the cast skin 4.

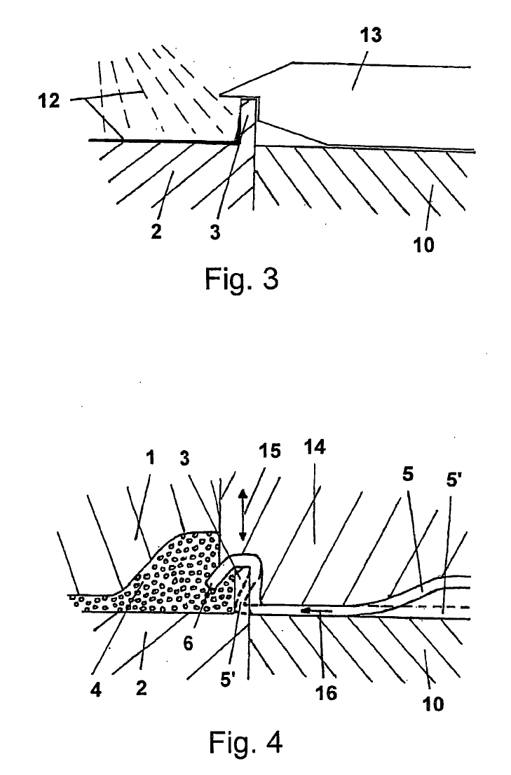

An earlier working step of a manufacturing method with the casting tool of FIG. 2 is to be seen in FIG. 3, with which recurring features are again provided with the same reference numerals. The lower tool 2 in the illustrated working step is sprayed with paint 12, wherein the region of the lower tool 2 which later accommodates the decor inlay, here, differently to the previously described procedure, is not protected by a lowering of the insert 10 but by way of a covering with a mask 13. A covering with the mask 3 in combination with a lowering of the insert 10 of the lower tool would also be possible.

A further variant of one manufacturing method according to the invention for a surface decor is shown in FIG. 4. Here too, the casting tool and the arising surface decor is shown in cross section, and the same features are again provided with identical reference numerals. What is different from the previously described examples is that here the upper tool 1 is designed in a divided manner with a middle part 14 which covers the decor inlay 5 and is designed liftable and lowerable in a direction illustrated by a double arrow 15. By way of this, one may exert a dosable pressure which may be set to various decor inlays, on the decor inlay 5, at the location at which this lies on the web 3 at the edging 6. The middle part 14 of the upper tool 1 is furthermore shaped such that it permits the introduction of the decor inlay 5 into the casting too with an over-dimensioning. The result of this is that after a subsequent removal of the surface decor from the casting tool and before rear-foaming for forming the trim part, the decor inlay 5 may be stretched by way of a slight deformation of the groove caused by the web 3, by which means the joint formed by the groove on the viewed side of the surface decor is closed. This joint, which otherwise leaves open a gap of a width of about 1 mm, has a disappearing width on the finished trim part due to this. An arrow 16 in the figure indicates in which direction the decor inlay 5 is displaced for closing the gap, by which means the decor inlay 5 comes into a foaming position 5′ which is indicated dashed in the figure.

1. A surface decor for a trim part which is formed in regions using a cast skin, comprising a first region formed exclusively by a decor inlay, an edging of the decor inlay bordering a second region of the surface decor which is formed by the cast skin, the edging of the decor inlay being enclosed by the cast skin.

2. A surface decor according to claim 1, wherein the trim part is an interior trim part for a motor vehicle.

3. A surface decor according to claim 1, wherein the cast skin consists of polyurethane.

4. A surface decor according to claim 1, wherein the cast skin has an average thickness of between 0.7 mm and 1.5 mm.

5. A surface decor according to claim 1, wherein a viewed surfaced of the cast skin which, when installed remains visible carries at least one of a paint layer and a light-insensitive layer.

6. A surface decor according to claim 1, wherein a viewed surface of the cast skin which, when installed remains visible, consists of a light-insensitive material.

7. A surface decor according to claim 1, wherein the decor inlay consists of one of leather, a textile and a polymeric material.

8. A surface decor according to claim 1, wherein the decor inlay has a thickness of between 0.3 mm and 2 mm.

9. A surface decor according to claim 1, wherein a rear side of the decor inlay which, when installed, is not visible includes a blocking layer.

10. A surface decor according to claim 1, wherein a rear side of the decor inlay which, when installed, is not visible is of a foam-tight nature.

11. A surface decor according to claim 1, wherein the edging of the decor inlay encompassed by the cast skin is closed.

12. A surface decor according to claim 1, wherein the surface decor defines a viewed surface which, when installed remains visible, the surface decor including a groove extending into a region of the viewed surface surrounding the edging so that the edging lies sunk in the groove so that a joint separating a first surface region formed by the cast skin from a second surface region formed by the decor inlay runs substantially parallel to the edging.

13. A surface decor according to claim 12, wherein a width of the joint is no more than approximately 1.5 mm.

14. A surface decor according to claim 12, wherein a width of the joint is no more than approximately 0.7 mm.

15. A surface decor according to claim 1, wherein portions of the cast skin and the decor inlay extending substantially perpendicular to the edging form an overlap of between 1 mm and 5 mm in length.

16. A surface decor according to claim 1, wherein portions of the cast skin and the decor inlay extending substantially perpendicular to the edging form an overlap of between 2 mm and 3 mm in length.

17. A surface decor according to claim 1, wherein the surface decor is adapted for incorporation in a trim part.

18. A surface decor according to claim 17, wherein the surface decor is adapted for incorporation in a trim part for an interior of a motor vehicle.

19. A surface decor according to claim 17, wherein the surface decor is adapted for incorporation in a trim part forming one of a side trim, a door interior trim and a constituent of an instrument panel.

20. A surface decor according to claim 17, including a foam applied to a rear surface thereof, which, when installed, is not visible.

21. A surface decor according to claim 17, the foam includes a polyurethane material.

22. A surface decor according to claim 17, further comprising a carrier.

23. A surface decor according to claim 22, wherein the carrier is manufactured of plastic.

24. A surface decor according to claim 22, wherein the carrier is manufactured of a pressed wood fiber shape material.

25. A surface decor according to claim 12, wherein a joint on the viewed side has a disappearing width.

26. A method for manufacturing a surface decor for a trim part, comprising:
introducing a decor inlay into a space between upper and lower tools of a casting tool;
clamping an edging of the decor inlay between the upper and lower tools so that the edging projects into a cavity formed between the upper and lower tools; and
filling the cavity between the upper and lower tools with a curing material to form a cast skin enclosing the edging after the decor inlay has been clamped between the upper and lower tools.

27. A method according to claim 26, wherein the trim part is an interior trim part for a motor vehicle.

28. A method according to claim 26 wherein the curing material includes polyurethane and wherein the cast skin resulting therefrom has an average thickness of between approximately 0.7 mm and 1.5 mm.

29. A method according to claim 26, further comprising, depositing a paint layer remaining on the cast skin onto a surface of the lower tool before filling the cavity covering a portion of the decor inlay with a mask.

30. A method according to claim 26, wherein the lower tool is divided such that a first region accommodating the decor inlay is lowerable relative to a second region of the lower tool accommodating the cast skin.

31. A method according to claim 26, wherein the lower tool comprises a web along a line separating the cavity from non-edge portions of the decor inlay, wherein the edging of decor inlay is clamped between this web and the upper tool, the upper tool comprising a recess for the web.

32. A method according to claim 31, wherein the web has at least one of (i) a width of between approximately 0.7 mm and 1.5 mm and (ii) a height of between approximately 3 mm and 10 mm.

33. A method according to claim 26, wherein the upper tool is divided such that a first region covering the decor inlay is liftable and lowerable relative to a second region separating non-edge regions of the decor inlay from the cavity.

34. A method according to claim 26, wherein decor inlay is held on one of the upper and lower tools by a vacuum.

35. A method according to claim 26, wherein the upper tool comprises a plurality of positioning pins, wherein the decor inlay is introduced into the casting tool with the edging bearing on the positioning pins.

36. A method according to claim 26, wherein the decor inlay forms a middle region of the surface decor encased peripherally by the cast skin.

37. A method according to claim 26, wherein the decor inlay is formed of one of leather, textile material and a polymer material.

38 A method according to claim 26, wherein a rear side of the decor inlay which is not visible when installed, includes one of a coating, a film and a blocking layer applied thereto.

39. A method according to claim 26, wherein a rear side of the decor inlay which is not visible when installed, consists of a foam-tight material.

40. A method according to claim 31, wherein a joint is created by the web and wherein a region formed between the cast skin and non-edge regions of the decor inlay is pushed together to reduce the joint to a disappearing gap after removal of the surface decor from the casting tool.

41. A casting tool for manufacturing a surface decor for a trim part, comprising: upper and lower tools which, when closed against one another, form a cavity therebetween, the upper and lower tools being movable toward and away from one another to open and close the cavity, wherein a first region of the cavity forms a space for the introduction thereto of a curing material to form a cast skin and a second region of the cavity forms a space for receiving therein a decor inlay, the first and second regions bordering one another along a sealing gap within which an edging of the decor inlay is clamped when the upper and lower tools are closed against one another, wherein the casting tool at the sealing gap is widened towards the cavity so that the edging of the decor inlay bears on edges of the sealing gap but not on walls of the cavity.

42. A casting tool according to claim 41, wherein the lower tool comprises a web extending along the sealing gap, the web delimiting the cavity and forming an edge of the sealing gap.

43. A casting tool according to claim 41, wherein the sealing gap forms a closed edging of the second region.

44. A casting tool according to claim 41, wherein one of the lower and upper tools is divided such that first and second regions thereof move independently of one another.

45. A casting tool according to claim 41, wherein one of the upper and lower tools comprises openings for applying a vacuum to the second region in a direction toward the other of the upper and lower tools.

46. A casting tool according to claim 41, wherein one of the upper and lower tools includes one of steel and aluminum.
